(19) United States
(12) Patent Application Publication
(10) Pub. No.: US 2019/0073637 A1
(43) Pub. Date: Mar. 7, 2019

(54) ONE CLICK OWNERSHIP TRANSFER

(71) Applicant: Microsoft Technology Licensing, LLC, Redmond, CA (US)

(72) Inventor: Suvarna Raju Madhey, Pune (IN)

(21) Appl. No.: 15/695,782

(22) Filed: Sep. 5, 2017

(51) Int. Cl. G06Q 10/10

(52) U.S. Cl. CPC G06Q 10/1053; G06Q 10/109; G06Q 10/107

(57) ABSTRACT

Various embodiments of the present technology generally relate to systems and methods for efficient role transfers within an organization. More specifically, some embodiments relate systems and methods for one click ownership transfer. In response to the one click ownership transfer, machine learning processors can analyze electronic records of an individual, categorize those records, and then determine which categories should be transferred to the successor. These classifications may include categories like personal, human resource related, project names, etc. The identified data relating to the role can then transferred the successor.

### BACKGROUND

Successful companies of all sizes need employees to work jointly together and collaborate on various projects, designs, and other endeavors. This is true of intellectually based endeavors as well as physically based endeavors. Many companies often create various divisions or teams of employees to focus on developing knowledge in specific areas. These employees can also be divided into specific roles within the company or even within those divisions or teams. Over time, employees will leave the organization, get promoted, or transfer to different roles within the organization and another individual will take responsibility for some or all of the activities of the role the employee is leaving. Unfortunately, the transfer of important information and data can be a difficult and time-consuming process.

For example, almost every organization now uses various types of personal productivity software that often includes a variety of software applications. These software applications can include word processing applications, spreadsheet applications, e-mail clients, notetaking software, presentation applications, digital image editing applications, and others. The applications available in these software suites are often used by individuals to communicate, organize meetings, create documents, create presentations, and create various reports. These applications can also be used to perform calculations, produce charts, organize data, receive and send e-mails, and the like. Unfortunately, there has traditionally not been an efficient and easy way of transferring these documents, files, e-mails and other information that may be relevant to the individual replacing the person being promoted, leaving or transferring roles.

Traditionally, massive data transfers such as granting access to an inbox of a former employee have been used. However, while this technique may be sufficient for e-mail transfers, other relevant files, meetings, or electronic records can still be missing. In addition, private e-mails from the employee may also be accessible. As such, unrestricted access to e-mails is rarely granted. In other cases, the employee leaving can manually search and forward specific e-mails, documents, meeting invites and the like. However, this can be time consuming and can easily result in missed transfers. The same difficulties apply for the removal the individual being promoted or addition of a replacement to be incorporated into meetings. When a former employee was the creator of a meeting or part of a standing meeting, significant effort must be taken to either recreate the meetings or ensure any new employee is automatically added to the list. As such, business continuity can be negatively impacted.

Overall, the examples herein of some prior or related systems and their associated limitations are intended to be illustrative and not exclusive. Upon reading the following, other limitations of existing or prior systems will become apparent to those of skill in the art.

### Overview

Various embodiments of the present technology generally relate to systems and methods for efficient role transfers within an organization. More specifically, some embodiments provide for improved systems and methods for implementing automated transfer of electronic records (e.g., audio files, video files, e-mails, reservations, meeting invites, distribution lists, electronic files associated with one or more productivity applications, and the like). In some embodiments, an individual can submit a (one-click) request to transfer electronic records. In response to the transfer request, data associated with a user can be identified and sorted into multiple classifications. These classifications may include categories like personal, human resource related, project names, etc. Some embodiments can use one or more machine learning classifiers (e.g., natural language processors, support vector machines, deep learning networks, etc.) and other data processing techniques (e.g., optical character recognition) to process and sort the data into the multiple classifications. The identified data relating to the role can then transferred the successor.

In some embodiments, the electronic records can include calendar invites which can be analyzed to determine whether the user is an owner of a first meeting invite. Then, in response to determination that the user is the owner of the first meeting invite, ownership can be automatically transferred to the successor. In accordance with various embodiments, the meeting invite can also be automatically updated. For example, the invites can be automatically update any video conference information or dial-in conference information on to video conference information or dial-in conference information corresponding to the successor.

Embodiments of the present invention also include computer-readable storage media containing sets of instructions to cause one or more processors to perform the methods, variations of the methods, and other operations described herein.

Some embodiments provide for a system having one or more processors, memory, a communication module, a transfer module, artificial intelligence processors, natural language processors, and/or other components for processing transfer requests. For example, in some embodiments, a communication module, under control of the processor, configured to receive a request to transfer an individual within an organization from a first role to a second role. The analysis module, under control of the processor, can automatically review using an artificial intelligence processor, in response to the request to transfer the individual from the first role to the second role, electronic records associated with the individual to identify electronic records associated with the first role. The transfer module can transfer (e.g., copying to folders, changing permissions, etc.) the electronic records (e.g., structured and unstructured) identified as being associated with the first role to a second user taking responsibility for the first role.

In some embodiments, the request to transfer includes specific topics and the transfer tool. The natural language processor can identify the specific topic within the electronic records and use that information for sorting and identifying relevant documents for the transfer. In one embodiment, an identification module, under control of the processor, can determine an identity of an individual that submitted the request to transfer by issuing a multifactor authentication challenge.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIG. 1 illustrates an example of an environment with a transfer tool capable of automatically identifying and transferring electronic records and privileges in accordance with some embodiments of the present technology;

FIG. 2 illustrates a set of components associated with a transfer tool that may be used in one or more embodiments of the present technology;

FIG. 3 illustrates an example of a set of operations for transferring ownership of various electronic records according to one or more embodiments of the present technology;

FIG. 4 illustrates an example of a set of operations for identifying and transferring e-mails according to one or more embodiments of the present technology;

FIG. 5 illustrates an example of a set of operations for providing a transferee access to identified documents according to one or more embodiments of the present technology;

FIG. 6 illustrates an example of a set of operations for updating meeting invites according to one or more embodiments of the present technology;

FIG. 7 illustrates an example of a set of operations for transferring ownership of e-mail aliases according to one or more embodiments of the present technology;

FIG. 8 illustrates a set of components that may be used according to one or more embodiments of the present technology;

FIG. 9 is a sequence diagram illustrating an example of the data flow between various components according to various embodiments of the present technology; and

FIG. 10 illustrates an example of a computing system, which is representative of any system or collection of systems in which the various applications, services, scenarios, and processes disclosed herein may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to systems and methods for efficient role transfers within an organization. More specifically, some embodiments relate systems and methods for one click ownership transfer. When an individual with an organization changes teams or roles, there are many items (e.g., electronic records) and tasks that would be beneficial to the replacement. Traditionally, individuals have needed to manually forward on relevant e-mails and documents, cancel existing meetings, unsubscribe from different groups, etc. Other items require involvement from the information technology department. For example, changing ownership of distribution lists, access privileges, and the like. These manual processes can be time consuming and prone to human error. Moreover, the transfer of some items can create undesirable impacts. For example, cancellation of a standing meeting will generate many notifications and require an additional invite from someone else. In addition, lack of proper transfer of these items and tasks can easily lead to a disruption in business continuity.

In contrast, various embodiments relate to a one-click transfer tool that removes the burden from the user by allowing the user to change ownership of various electronic records more easily. Some embodiments provide a successor capability in an e-mail application (or other productivity application) that once activated can simplify the transfer process from one user to another. Seamless transfer can be initiated by a supervisor or an individual based on the requirement and without impacting anyone completes in the background.

Various embodiments of the present technology provide for a wide range of technical effects, advantages, and/or improvements to computing systems and components. For example, various embodiments include one or more of the following technical effects, advantages, and/or improvements: 1) reducing the number of user interactions when to transfer e-mails, notes, documents, meetings, distributions lists, privileges, and the like when an employee leaves an organization or transfers roles; 2) use of machine learning techniques to automatically identify relevant electronic records to transfer to an individual assuming responsibilities of the role of the individual that is leaving or being transferred; 3) providing a transfer system for seamlessly identifying and transferring meeting invites; 4) creating improvements to the way computing devices operate; 5) use unconventional and non-routine operations as part of transferring electronic records and privileges; 6) use of custom links and graphical user interfaces for requesting automatic transfer evaluations; and/or 7) changing the manner in which a computing system reacts to individual role changes or departures. Some embodiments include additional technical effects, advantages, and/or improvements to computing systems and components.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

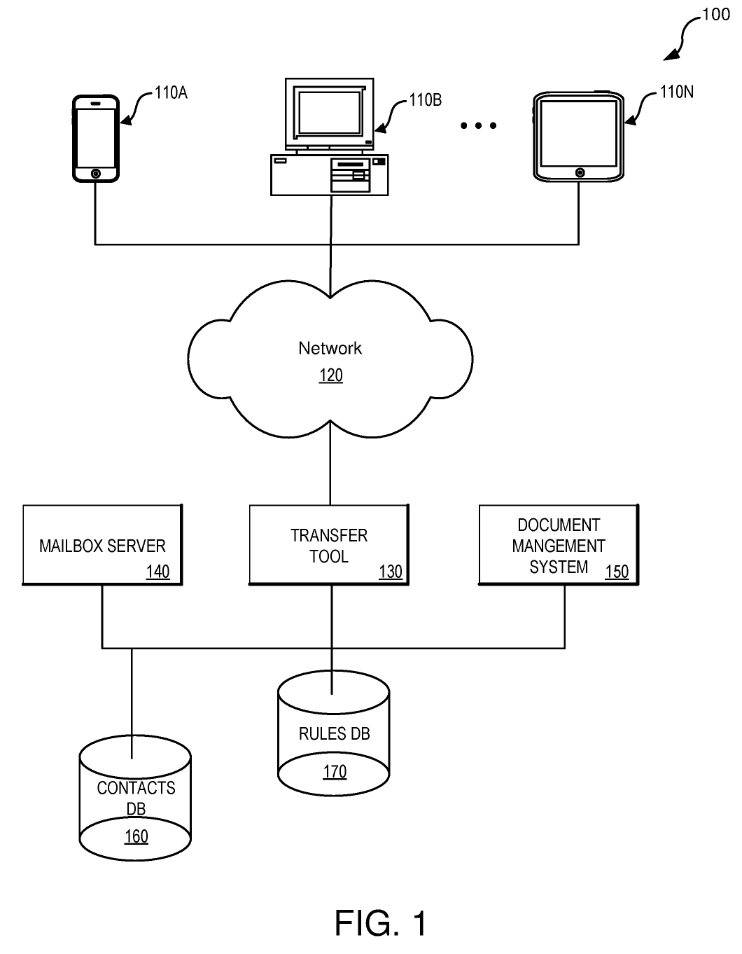

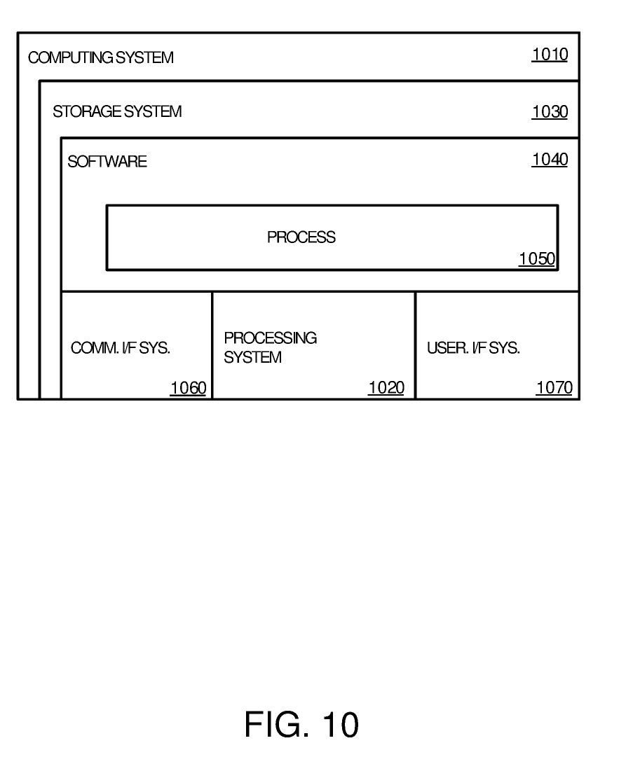

FIG. 1 illustrates an example of an environment 100 with a transfer tool capable of automatically identifying and transferring electronic records and privileges in accordance with some embodiments of the present technology. As illustrated in FIG. 1, environment 100 may include one or more computing devices 110A-110N, communications network 120, transfer tool 130, mailbox server 140, document management system 150, and various databases such as contacts database 160, and rules database 170. Computing devices 110A-110N can be any computing system capable of running an application natively or in the context of a web browser, streaming an application, or executing an application in any other manner. Examples of computing devices 110A-110N include, but are not limited to, personal computers, mobile phones, tablet computers, mobile media device, desktop computers, laptop computers, wearable computing devices, or any other form factor, including any combination of computers or variations thereof. Computing devices 110A-110N may include various hardware and software elements in a supporting architecture suitable for providing various productivity applications that can access transfer tool 130, mailbox server 140, and/or document management system 150. One such representative architecture of a computing device is illustrated in FIG. 10 with respect to computing system 1010.

Those skilled in the art will appreciate that various components (not shown) may be included in computing devices 110A-110N to enable network communication with communication network 120. In some cases, communication network 120 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

Transfer tool 130 can be integrated with, or communicably coupled to mailbox server 140 and/or document management system 150. In accordance with various embodiments, transfer tool 130 can process a transfer request and, in response, automatically analyze documents and other electronic records (e.g., e-mails, calendar invites, etc.) to identify records that may be beneficial to someone assuming a role being vacated. The transfer tool can copy documents and records, change access privileges, organize the information, and perform other actions that make the transition easier. For example, transfer tool 130 can provide a successor capability in productivity applications (e.g., e-mail application) which can simplify transfer process from one user to another. Seamless transfer can be initiated by a supervisor or an individual and without impacting anyone, transfer tool 130 can complete transfer actions in the background eliminating unnecessary interactions and traffic.

Contact database 160 can include a set of contacts and corresponding information about each contact. These can be part of the electronic records that need to be transferred. For example, a user may have an external contact for placing various orders. The transfer tool, upon analyzing e-mails and phone records, can determine orders are routinely placed to this contact. As such, the contract information should be transferred to the successor.

Rules database 170 can be used to store the models (e.g., statistical models) created from transfer tool 130. These models can provide information about how the various electronic records are related and organized. In addition, rules database 170 may also provide rules for certain categorizations. For example, records (e.g., e-mails) related to reviews or pay can be appropriately categorized by the analysis of transfer tool 130. Rules database 170 can indicate that these records should not be transferred to the successor.

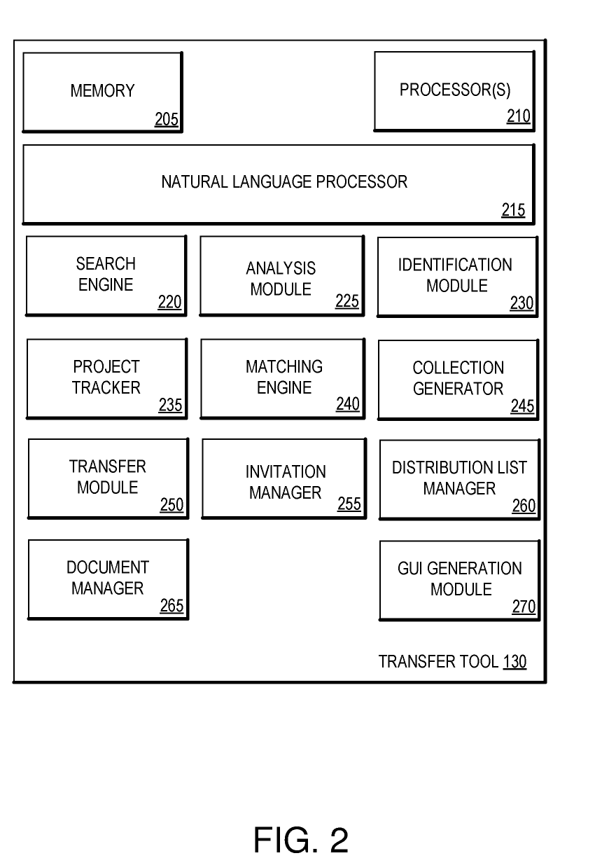

FIG. 2 illustrates a set of components associated with a transfer tool 130 that may be used in one or more embodiments of the present technology. According to the embodiments shown in FIG. 2, transfer tool 130 can include memory 205, one or more processors 210, natural language processor 215, search engine 220, analysis module 225, identification module 230, project tracker 235, matching engine 240, collection generator 245, transfer module 250, invitation manager 255, distribution list manager 260, document manager 265, and graphical user interface (GUI) generation module 270. Each of these modules can be embodied as special-purpose hardware (e.g., one or more ASICS, PLDs, FPGAs, or the like), or as programmable circuitry (e.g., one or more microprocessors, microcontrollers, or the like) appropriately programmed with software and/or firmware, or as a combination of special purpose hardware and programmable circuitry. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, the functionality of invitation manager 255, distribution list manager 260, and document manager 265 may be combined into a single module or system.

Memory 205 can be any device, mechanism, or populated data structure used for storing information. In accordance with some embodiments of the present technology, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of natural language processor 215, search engine 220, analysis module 225, identification module 230, project tracker 235, matching engine 240, collection generator 245, transfer module 250, invitation manager 255, distribution list manager 260, document manager 265, and/or GUI generation module 270. In some embodiments, transfer tool 130 may include an operating system (not shown) that can provide a software package that is capable of managing the hardware resources of transfer tool 130. In some embodiments, operating system can also provide common services for software applications running on processor(s) 210.

Natural language processor 215 can be used to analyze the electronic records and generate various statistical inferences enabling data extraction, relationship extraction, text mining, language translation, tagging, tokenization, and other features that may be used by transfer tool 130 in sorting and identify electronic records. In some embodiments, natural language processor 215 can use various deep learning techniques in analyzing the electronic records including audio and video files. For example, some organizations may forward voicemails to e-mail inboxes of the recipient. As such, natural language processor 215 can analyze those recordings to identify topics or subjects.

Search engine 220 can search electronic records to identify those associated with user. This may include identifying e-mail accounts, cloud-storage accounts, files stored within a document management system, entries within calendar and reservations systems, and the like. Once identified, analysis module 225 can analyze the electronic records using various machine learning techniques (e.g., support vector machines, deep learning, neural networks, supervised learning techniques, unsupervised learning techniques, clustering techniques, etc.)

Identification module 230 can be configured to determine an identity of an individual that submitted the request to transfer. In accordance with various embodiments, identification module 230 may use various challenges, records, and authentication techniques (e.g., by issuing a multifactor authentication challenge). Project tracker 235 can use information about particular project to aid in the analysis, collection, and transfer or records. For example, project tracker 235 can access a database to determine individuals assigned to a specific project, project numbers, key words, and other specific project data. This information can be used by analysis module 225 and/or natural language processor 215 in the record classification and identification. Matching engine 240 can match the successor with one or more individuals that may be able to assist with knowledge transfer. For example, in some embodiments, matching engine 240 can identify the one or more individuals based on length of time within this role, e-mail traffic, placement within organizational chart, and the like. Collection generator 245 analyze collections of information from multiple different sources to identify additional documents that may be useful to the successor.

Transfer module 250 can transfer the electronic records identified as being associated with the first role to a second user taking responsibility for the first role. In some embodiments, transfer module 250 may use invitation manager 255, distribution list manager 260, and document manager 265 to transfer ownership or copy the records. Transfer module 250 may use invitation manager 255, distribution list manager 260, and document manager 265 can interface with calendaring systems, notification systems, and document storage systems, respectfully. These components can manage the transfer requirements needed specifically for each of these systems. GUI generation module 270 can generate one or more GUI screens that allow for interaction with a user. In at least one embodiment, GUI generation module 270 can generate a graphical user interface allowing a user to request transfers and easily review and search transferred records.

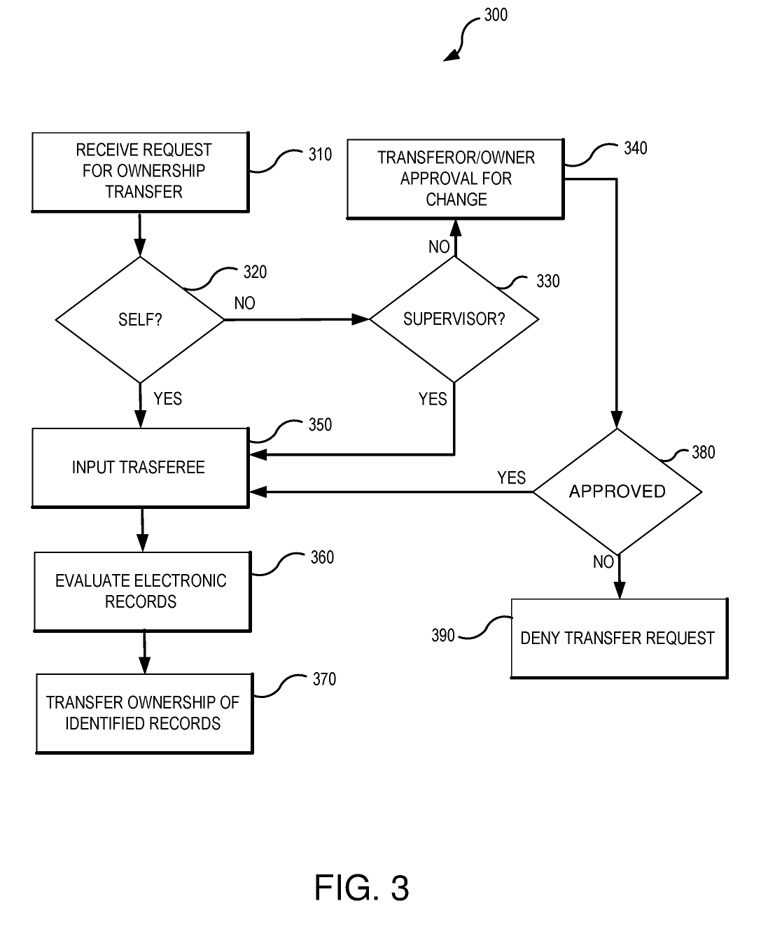

FIG. 3 illustrates an example of a set of operations 300 for transferring ownership of various electronic records according to one or more embodiments of the present technology. These operations may be performed by various systems or components such as, but not limited to, transfer tool 130, processors 210, natural language processor 215, search engine 220, analysis module 225, identification module 230, project tracker 235, matching engine 240, collection generator 245, transfer module 250, invitation manager 255, distribution list manager 260, document manager 265, GUI generation module 270, and/or other component, computing device, or module.

As illustrated in FIG. 3, request operation 310 receives a request to transfer ownership. In accordance with various embodiments, the request may be triggered by an individual (e.g., the employee leaving or a manager) via a graphical user interface. In other embodiments, the request may be triggered by a human resource (HR) system in response to a status change (e.g., a change in role, office location, employment status, etc.). The request may identify a specific type of electronic records to be reviewed and transferred (e.g., e-mails, notes, aliases, meeting invites, distribution lists, etc.). As a default, all available types of electronic records may be searched or the requestor can modify the selection. In some embodiments, the request may also limit the transfer to specific topics, project information, keywords, time periods, or other types of limits. This may be useful, for example, when a part of a role of an employee is being moved to another employee.

Once a request had been received, self determination operation 320 can determine if the request came from the individual. This can be based on a variety of information, signatures, authorized tokens, and the like. In some cases, self determination operation 320 may trigger a round of multi-factor authentications to verify the identity. When self determination operation 320 determines that the request did not originate from the individual, self determination operation 320 can branch to supervisor determination operation 330 where a determination is made whether a supervisor or HR system generated the request. When supervisor determination operation 330 determines that a supervisor or HR system did not generate the request, the supervisor determination operation 330 can branch to approval operation 340 where any need approval workflow can be initiated before completing the record evaluation and transfer.

When self determination operation 320 determines that the request did originate from the individual or supervisor operation 330 determines that a supervisor made the request, operation 320 or 330 can branch to identification operation 350 where the transferee can be identified. This may be done, for example, by the requestor entering an e-mail address, an alias of the individual, selecting the individual from a list, and the like. Once the destination individual has been identified, evaluation operation 360 can evaluate the electronic records. In some cases, specific electronic records (e.g., e-mail but not meeting invites) may be identified as part of the request. In that case, evaluation operation 360 would only evaluate the selected type of records. Similarly, any specific limitations on subject or topic may also be used to restrict or set criteria for evaluation. In accordance with various embodiments, evaluation operation 360 can use a variety of systems such as natural language processors, machine learning systems and classifiers, structured and unstructured search engines, and the like as part of the evaluation process. Once the records have been identified, transfer operation 370 can transfer (e.g., copy, move, set permissions, etc.) the records allowing access by the transferee.

Approval operation 340 branches to approval determination operation 380 where a determination is made as to whether the transfer has been approved. When approval determination operation 380 determines that the approval was granted, then approval determination operation 380 branches to identification operation 350 as described above. When approval determination operation 380 determines that the approval was not granted, then approval determination operation 380 branches to denial operation 390 where the transfer request is denied.

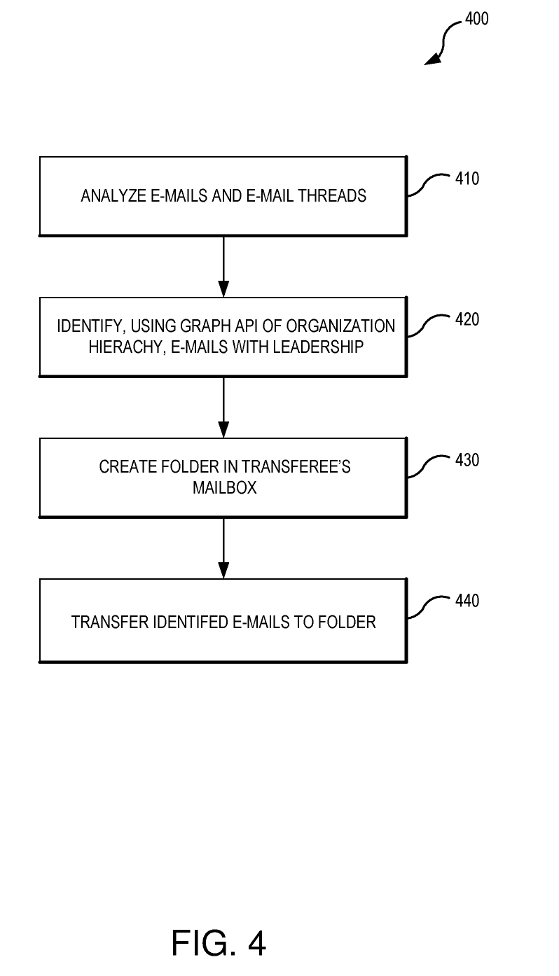

FIG. 4 illustrates an example of a set of operations 400 for identifying and transferring e-mails according to one or more embodiments of the present technology. These operations may be performed by various systems or components such as, but not limited to, transfer tool 130, processors 210, natural language processor 215, search engine 220, analysis module 225, identification module 230, project tracker 235, matching engine 240, collection generator 245, transfer module 250, invitation manager 255, distribution list manager 260, document manager 265, GUI generation module 270, and/or other component, computing device, or module.

As illustrated in FIG. 4, analysis operation 410 analyses the e-mails and e-mail threads. This analysis can be done, for example, with natural language processors and/or machine learning techniques such as, but not limited to classifiers, deep learning techniques, supervised or unsupervised learning and the like. In some embodiments, analysis operation 410 may use any available information (e.g., metadata, recipient list, subject lines, etc.) in addition to e-mail content as part of the analysis. Relevant e-mails identified by analysis operation 410 can then be further sorted or identified using identification operation 420 where a graph API of organizational hierarchy can be used to identify e-mails to leadership.

Creation operation 430 can create a new folder within a transferee's mailbox and transfer operation 440 can transfer any identified e-mail to the new folder. In some embodiments, a notification may be sent to the transferee along with a request for storage preferences. This notification may be sent, for example, before the creation of the new folder or the first time the transferee opens an e-mail application after the transfer is complete. If the transferee fails to respond, then a default storage setting can be used.

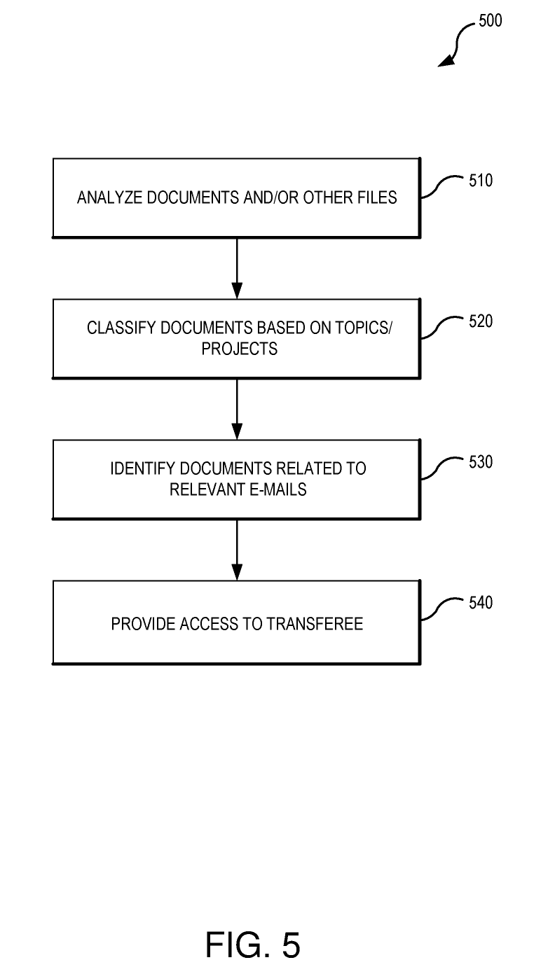

FIG. 5 illustrates an example of a set of operations 500 for providing a transferee access to identified documents according to one or more embodiments of the present technology. These operations may be performed by various systems or components such as, but not limited to, transfer tool 130, processors 210, natural language processor 215, search engine 220, analysis module 225, identification module 230, project tracker 235, matching engine 240, collection generator 245, transfer module 250, invitation manager 255, distribution list manager 260, document manager 265, GUI generation module 270, and/or other component, computing device, or module.

As illustrated in FIG. 5, analysis operation 510 can analyze documents and/or other files stored within a document management system, locally one a user's device, and/or associated cloud-based storage system. This analysis can be done, for example, with natural language processors and/or machine learning techniques such as, but not limited to classifiers, deep learning techniques, supervised or unsupervised learning and the like. Classification operation 520 can then classify documents based topics, projects, or other classification criteria. For example, some documents may be classified in other ways such as, but not limited to, as personal, sensitive, HR related (e.g., pay, reviews, etc.), and the like. In addition, relevance operation 530 can also analyze the documents and/or other files based on identified e-mails. Transfer operation 540 can provide access to the identified files with classifications that should be transferred. In some embodiments, transfer operation may copy some of the documents to storage accessible by the transferee. In other embodiments, permissions may be changed to allow access to the identified documents.

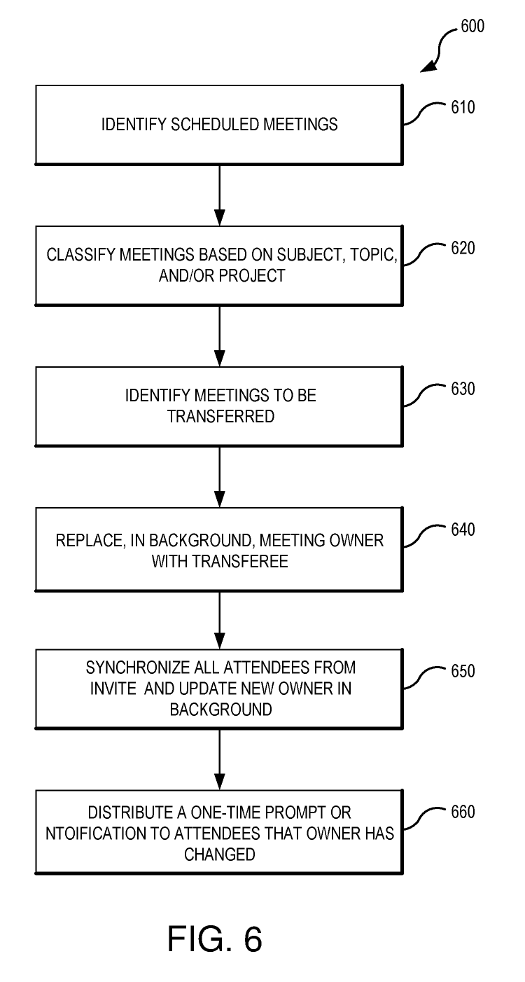

FIG. 6 illustrates an example of a set of operations 600 for updating meeting invites according to one or more embodiments of the present technology. These operations may be performed by various systems or components such as, but not limited to, transfer tool 130, processors 210, natural language processor 215, search engine 220, analysis module 225, identification module 230, project tracker 235, matching engine 240, collection generator 245, transfer module 250, invitation manager 255, distribution list manager 260, document manager 265, GUI generation module 270, and/or other component, computing device, or module.

As illustrated in FIG. 6, identification operation can search a calendar system or room reservation system to identify scheduled meetings. Using available information, classification operation 620 can classify the meetings based on subject, topic, project, etc. Selection operation 630 can identify meetings that need to be transferred to the transferee. Once selection operation 630 has identified the meetings, replacement operation 640 can change the meeting owner (if the meeting is owned by the original user leaving or changing roles) or replace the user as a participant. In accordance with some embodiments, this transfer may be done in the background to prevent needless e-mail traffic cancelling and rescheduling meetings. Synchronization operation 650 can then synchronize all attendees from the invite and optionally update the new owner in the background.

In some embodiments, synchronization operation 650 can change conference calling details (e.g., links, passcodes, etc.). Notification operation 660 may be used in some embodiments to distribute a one-time prompt or notification to attendees that the owner or participant has changed. In some embodiments, notification operation 660 may use an organizational chart to select and only notify one individual to ensure any needed information communicated to the new owner/attendee.

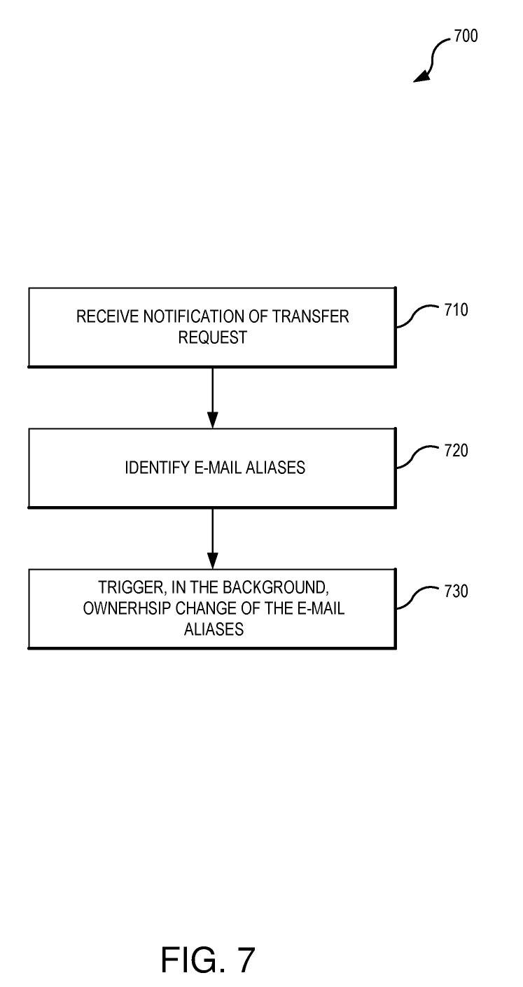

FIG. 7 illustrates an example of a set of operations 700 for transferring ownership of e-mail aliases according to one or more embodiments of the present technology. These operations may be performed by various systems or components such as, but not limited to, transfer tool 130, processors 210, natural language processor 215, search engine 220, analysis module 225, identification module 230, project tracker 235, matching engine 240, collection generator 245, transfer module 250, invitation manager 255, distribution list manager 260, document manager 265, GUI generation module 270, and/or other component, computing device, or module. As illustrated in FIG. 7, receiving operation 710 can receive a notification of transfer request. The request can include a variety of information including timing of the transfer, transferee, requested completion date, current user role, location, user transferring roles or leaving the organization, and the like. Using this information identification operation 720 can identify one or more e-mail aliases associated with the user. Transfer operation 730 can trigger an ownership change of the one or more e-mail aliases.

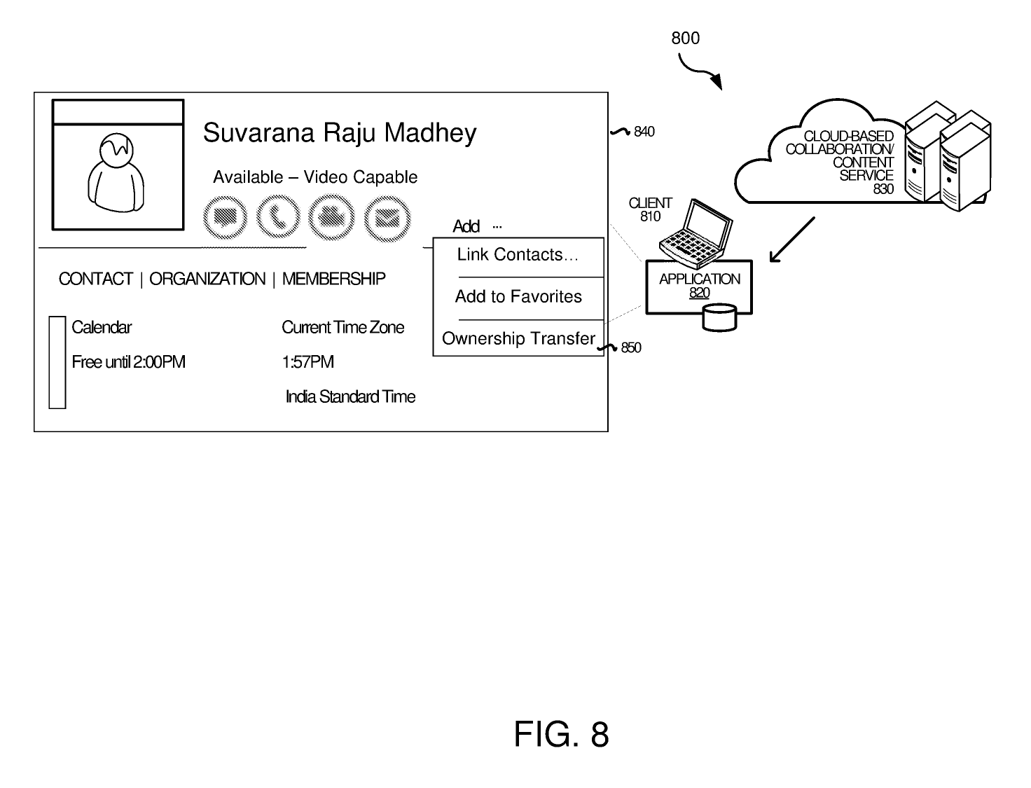

FIG. 8 illustrates a set of components 800 that may be used according to one or more embodiments of the present technology. As illustrated in FIG. 8, client device 810 can run one or more productivity applications 820 (e.g., word processing applications, e-mail applications, video chat applications, etc.) that can store electronic records in cloud-based collaboration/content service 830. The collaboration or content service 830 is representative of any service providing shared access to cloud-based or centralized communication, content, and centralized storage. As shown in the example of FIG. 8, a GUI 840 can be opened on client device 810 with productivity application 820. The productivity application 820 can include functionality including GUIs (graphical user interface) running on client device 810, e.g., a PC, mobile phone device, a Web server, or other application servers. Such systems may employ one or more virtual machines, containers, or any other type of virtual computing resource. GUI 840 represents an example of a contact within an e-mail application that includes an ownership transfer request 850. The us can click on ownership transfer request 850 to initiate a transfer and select one or more transferee.

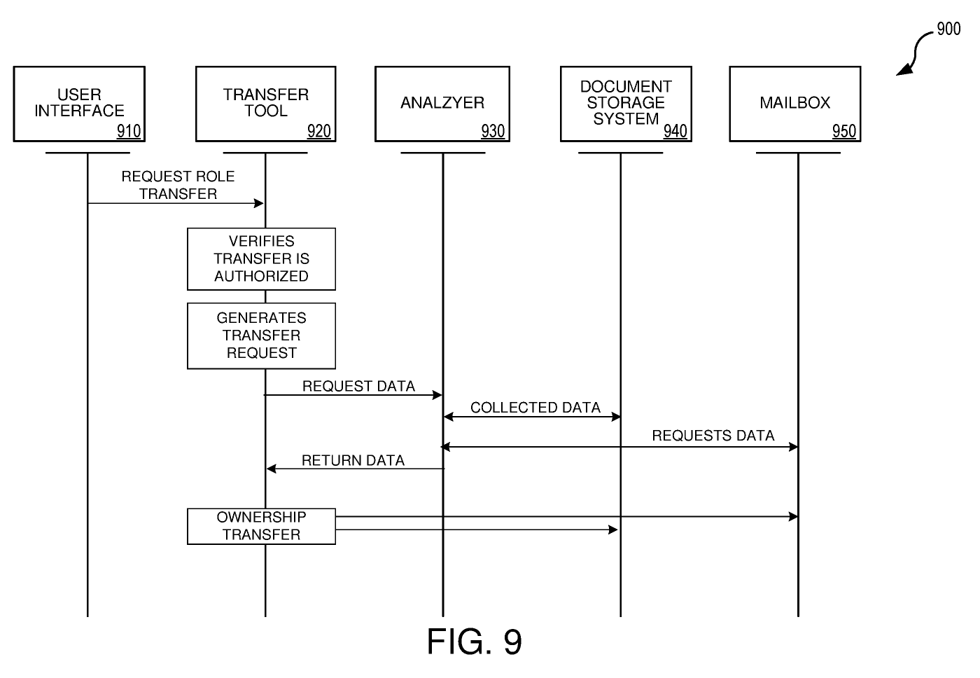

FIG. 9 is a sequence diagram illustrating an example of the data flow between various components according to various embodiments of the present technology. As illustrated in FIG. 9, a user can submit a role transfer request via user interface 910. Once the request is received by transfer tool 920, the transfer tool can verity transfer authorization (e.g., user, supervisor, etc.). The user may be prompted to enter a successor/transferee (e.g., via user interface 910). Then, transfer tool 920 can generate a transfer request that is submitted to analyzer 930. The analyzer can collect data from document storage system 940, mailbox 950, and/or other sources (e.g., user's computer or mobile device). This data can be sorted and identified to transfer tool 920 which can change the ownership and/or copy the files to the transferee. In accordance various embodiments, transfer tool 920 and analyzer 930 may have a variety of different techniques (e.g., natural language processing techniques, machine learning techniques, etc.) for searching and evaluating e-mails, document mining, calendar entries, team affiliations, aliases.

FIG. 10 illustrates computing system 1010, which is representative of any system or collection of systems in which the various applications, services, scenarios, and processes disclosed herein may be implemented. For example, computing system 1010 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 1010 may be implemented as a single apparatus, system, or device or may be implemented in a distributed manner as multiple apparatuses, systems, or devices. Computing system 1010 includes, but is not limited to, processing system 1020, storage system 1030, software 1040, applications 1050, communication interface system 1060, and user interface system 1070. Processing system 1020 is operatively coupled with storage system 1030, communication interface system 1060, and an optional user interface system 1070.

Processing system 1020 loads and executes software 1040 from storage system 1030. When executed by processing system 1020 for deployment of scope-based certificates in multi-tenant cloud-based content and collaboration environments, software 1040 directs processing system 1020 to operate as described herein for at least the various processes, operational scenarios, and sequences discussed in the foregoing implementations. Computing system 1010 may optionally include additional devices, features, or functionality not discussed for purposes of brevity.

Referring still to FIG. 10, processing system 1020 may comprise a micro-processor and other circuitry that retrieves and executes software 1040 from storage system 1030. Processing system 1020 may be implemented within a single processing device, but may also be distributed across multiple processing devices or sub-systems that cooperate in executing program instructions. Examples of processing system 1020 include general purpose central processing units, application specific processors, and logic devices, as well as any other type of processing device, combinations, or variations thereof.

Storage system 1030 may comprise any computer readable storage media readable by processing system 1020 and capable of storing software 1040. Storage system 1030 may include volatile and nonvolatile, removable and non-removable media implemented in any method or technology for storage of information, such as computer readable instructions, data structures, program modules, or other data. Examples of storage media include random access memory, read only memory, magnetic disks, nonvolatile memory, battery backed memory, Non-Volatile DIMM memory, phase change memory, memristor memory, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1030 may also include computer readable communication media over which at least some of software 1040 may be communicated internally or externally. Storage system 1030 may be implemented as a single storage device, but may also be implemented across multiple storage devices or sub-systems co-located or distributed relative to each other. Storage system 1030 may comprise additional elements, such as a controller, capable of communicating with processing system 1020 or possibly other systems.

Software 1040 may be implemented in program instructions and among other functions may, when executed by processing system 1020, direct processing system 1020 to operate as described with respect to the various operational scenarios, sequences, and processes illustrated herein. For example, software 1040 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1040 may include additional processes, programs, or components, such as operating system software, virtual machine software, or application software. Software 1040 may also comprise firmware or some other form of machine-readable processing instructions executable by processing system 1020.

In general, software 1040 may, when loaded into processing system 1020 and executed, transform a suitable apparatus, system, or device (of which computing system 1010 is representative) overall from a general-purpose computing system into a special-purpose computing system. Indeed, encoding software on storage system 1030 may transform the physical structure of storage system 1030. The specific transformation of the physical structure may depend on various factors in different implementations of this description. Examples of such factors may include, but are not limited to, the technology used to implement the storage media of storage system 1030 and whether the computer-storage media are characterized as primary or secondary storage, as well as other factors.

For example, if the computer readable storage media are implemented as semiconductor-based memory, software 1040 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1060 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 1070 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 1070. In some cases, the input and output devices may be combined in a single device, such as a display capable of displaying images and receiving touch gestures. The aforementioned user input and output devices are well known in the art and need not be discussed at length here. In some cases, the user interface system 1070 may be omitted when the computing system 1010 is implemented as one or more server computers such as, for example, blade servers, rack servers, or any other type of computing server system (or collection thereof).

User interface system 1070 may also include associated user interface software executable by processing system 1020 in support of the various user input and output devices discussed above. Separately or in conjunction with each other and other hardware and software elements, the user interface software and user interface devices may support a graphical user interface, a natural user interface, an artificial intelligence (AI) enhanced user interface that may include a virtual assistant or bot (for example), or any other type of user interface, in which a user interface to a productivity application may be presented.

Communication between computing system 1010 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and Figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A transfer tool comprising:
a memory;
a processor;
a communication module, under control of the processor, configured to receive a request to transfer an individual within an organization from a first role to a second role;
an analysis module, under control of the processor, automatically review using an artificial intelligence processor, in response to the request to transfer the individual from the first role to the second role, electronic records associated with the individual to identify electronic records associated with the first role; and
a transfer module, under control of the processor, configured to transfer the electronic records identified as being associated with the first role to a second user taking responsibility for the first role.

2. The transfer tool of claim 1, wherein the electronic records include e-mails, calendar invites, contact information, distribution lists, or electronic files associated with a productivity application.

3. The transfer tool of claim 1, wherein the request to transfer includes specific topics and the transfer tool further comprises a natural language processor to identify the specific topic within the electronic records.

4. The transfer tool of claim 3, wherein the electronic records include structured and unstructured records.

5. The transfer tool of claim 1, further comprising an identification module, under control of the processor, to determine an identity of an individual that submitted the request to transfer by issuing a multifactor authentication challenge.

6. The transfer tool of claim 1, wherein the artificial intelligence processor also applies a clustering analysis to the electronic records to group the electronic records into multiple categories that are used to identify electronic records associated with the first role.

7. A computer-readable medium having instructions stored thereon instructions that when executed by one or more processors cause a machine to:
identify, in response to a request to transfer ownership of data associated with an alias, data associated with a user of the alias that is stored within the machine,
wherein the alias identifies the user of a computing platform having access to multiple productivity applications; and
sorting the data associated with the user into multiple classifications,
wherein one or more machine learning classifiers are applied to the data associated with the user to sort the data into the multiple classifications;
generate a graphical user interface that includes a window prompting identification of a successor to the user; and
transfer at least a portion of the data within the multiple classifications to the successor.

8. The computer-readable medium of claim 7, wherein the machine learning classifiers include natural language processors, support vector machines, or deep learning networks.

9. The computer-readable medium of claim 7, wherein the data includes images and the instructions when executed by the one or more processors cause the machine to execute an optical character recognition routine to identify text within the images.

10. The computer-readable medium of claim 7, wherein the data include audio files, video files, e-mails, reservations, meeting invites, distribution lists, or electronic files associated with one or more productivity applications.

11. The computer-readable medium of claim 7, wherein the data includes meeting invites and wherein the instructions when executed by the one or more processors cause the machine to:
determine whether the user is an owner of a first meeting invite; and
automatically transfer, in response to determination that the user is the owner of the first meeting invite, ownership to the successor.

12. The computer-readable medium of claim 11, wherein the instructions when executed by the one or more processors cause the machine to automatically update video conference information or dial-in conference information on the first meeting invite to video conference information or dial-in conference information corresponding to the successor.

13. The computer-readable medium of claim 7, wherein the data includes e-mails wherein the instructions when executed by the one or more processors cause the machine to:
create a new folder in a mailbox of the successor; and
automatically copy e-mails to the new folder in the mailbox of the successor.

14. The computer-readable medium of claim 7, wherein the instructions when executed by the one or more processors cause the machine to validate the request by issuing a multifactor authentication request.

15. The computer-readable medium of claim 7, wherein the request is an automatically generated request initiated from a human resource system in response to a change in status of the user.

16. The computer-readable medium of claim 15, wherein the change of status of the user includes a role change or a departure indicator.

17. A method comprising:
receiving a request to transfer a first individual within an organization from a first role to a second role;
automatically reviewing, in response to the request to transfer the first individual from the first role to the second role, electronic records associated with the first individual to identify electronic records associated with the first role,
wherein a machine learning processor is used to identify the electronic records associated with the first role; and
transferring the electronic records identified as being associated with the first role to a second individual taking responsibility for the first role.

18. The method of claim 17, wherein the electronic records include e-mails, calendar invites, distribution lists, or electronic files associated with one or more productivity applications.

19. The method of claim 18, further comprising, for each calendar invite identified as being associated with the first role:
determining whether the first individual is an owner of the calendar invite; and
automatically transferring, in response to determination that the first individual is the owner of the calendar invite, ownership to the second individual; and
automatically updating any video conference information or dial-in conference information in the calendar invite to video conference information or dial-in conference information corresponding to the second individual.

20. The method of claim 17, wherein the machine learning processor performs a clustering analysis sort the electronic records into multiple topics and the method further comprises creating one or more folders each titled with the multiple topics and copying electronic records into the one or more folders.
